(19) United States
(12) Patent Application Publication
(10) Pub. No.: US 2008/0309609 A1
(43) Pub. Date: Dec. 18, 2008

(54) Liquid crystal display device with scanning voltage adjusting circuit and method for driving same

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/214,173

(22) Filed: Jun. 16, 2008

(30) Foreign Application Priority Data
Jun. 15, 2007 (CN) 200710075057.8

(51) Int. Cl. G09G 3/36

(52) U.S. Cl. 345/101

(57) ABSTRACT

An exemplary liquid crystal display device includes a scanning voltage adjusting circuit (250), a scaler (220), and a liquid crystal display panel (200). The scanning voltage adjusting circuit is configured for detecting an environment temperature and generating a scanning voltage adjusting signal corresponding to the environment temperature. The scaler is capable of receiving the scanning voltage adjusting signal and generating a scanning voltage according to the scanning voltage adjusting signal. The liquid crystal display (LCD) panel is configured to be driven by the scanning voltage and thereby display images.

### FIELD OF THE INVENTION

The present invention relates to liquid crystal display (LCD) devices and methods for driving LCD devices, and particularly to an LCD device with a scanning voltage adjusting circuit and a method for driving such LCD device.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace cathode ray tube (CRT) monitors and televisions.

FIG. 3 is an abbreviated circuit diagram of a conventional LCD device. The LCD device 10 includes a scaler 130, a data driver 110, a scanning driver 112, a multiplicity of data lines 141 connected to the data driver 10, and a multiplicity of scanning lines 142 connected to the scanning driver 112. The data lines 141 are arranged parallel to each other with each data line 141 aligned parallel to a first direction. The scanning lines 142 are arranged parallel to each other with each scanning line 142 aligned parallel to a second direction that is perpendicular to the first direction. Thereby, the crossing data lines 141 and scanning lines 142 cooperatively define a multiplicity of pixel regions 106.

Each pixel region 106 has a thin film transistor (TFT) 101, a pixel electrode 102, a common electrode 103 generally opposite to the pixel electrode 102, a liquid crystal layer (not shown) sandwiched between the pixel electrode 102 and the common electrode 103, and a storage capacitor 104. The pixel electrode 102, the common electrode 103, and the liquid crystal layer sandwiched therebetween cooperatively define a liquid crystal capacitor (not labeled). The storage capacitor 104 is connected with the liquid crystal capacitor in parallel.

The TFT 101 includes a gate electrode (not labeled) connected to the corresponding scanning line 142 for receiving scanning signals therefrom, a source electrode (not labeled) connected to the corresponding data line 142 for receiving display signals therefrom, and a drain electrode (not labeled) connected to the pixel electrode 103 and the storage capacitor 104 for providing display signals thereto.

In operation, the scaler 130 outputs data signals and scanning signals to the data driver 110 and the scanning driver 112, respectively. In a first time period, the scanning driver 112 provides a switch-on voltage VGH to the gate electrode of the TFT 101 of each pixel region 106 via the corresponding scanning line 142. Thus the TFT 101 is switched on, and the data driver 110 then provides a gray scale voltage to the pixel electrode 102 and the storage capacitor 104 via the corresponding data line 141 and the activated TFT 101. The liquid crystal capacitor and the storage capacitor 104 are charged to the gray scale voltage for displaying images. In a second time period, the scanning driver 112 provides a switch-off voltage VGL to the gate electrode of the TFT 101 via the scanning line 142. Thus, the TFT 101 is switched off. The gray scale voltage of the liquid crystal capacitor and the storage capacitor 104 is maintained for displaying of images by the LCD device 10.

Generally, the TFT 101 is made from semiconductor material. Typically, the electrical properties of the semiconductor material are sensitive to changes in temperature. When the temperature rises or drops, electrical properties of the TFT 101, such as the current density-voltage (I-V) curve, can change dramatically. The dramatically changed electrical properties may adversely influence the display quality of the LCD device 10.

FIG. 4 shows I_{d}-V_{g} curves of a sample one of the TFTs 101 of the LCD device 10 at different temperatures. I_{d} represents a current density flowing through the TFT 101. V_{g} represents a scanning voltage applied to the gate electrode of the TFT 101. Curve T₀ represents an I_{d}-V_{g} curve of the TFT 101 at room temperature. Curve T₁ represents an I_{d}-V_{g} curve of the TFT 101 at a temperature higher than room temperature. Curve T₂ represents an I_{d}-V_{g} curve of the TFT 101 at a temperature lower than room temperature.

In the LCD field generally, the switch-on voltage VGH of the TFT 101 is set at a point corresponding to a stable high current Iₒₙ, and the switch-off voltage VGL of the TFT 101 is set at a point corresponding to the lowest current I_{off}. Under conditions where the temperature drifts higher or lower, the switch-on voltages corresponding to the stable high current drift to become VGH₁ and VGH₂, and the switch-off voltages VGL corresponding to the lowest current drift to become VGL₁ and VGL₂. However, in the LCD device 10, the switch-on and switch-off voltages are predetermined and fixed at VGH and VGL. When the temperature changes, under the control of the switch-on voltage VGH, the switch-on current is Iₒₙ₁ or Iₒₙ₂. The switch-on current Iₒₙ₁ is higher than the predetermined current Iₒₙ₁ and the switch-on current Iₒₙ₂ is lower than the predetermined current Iₒₙ. The higher switch-on current Iₒₙ₁ and the lower switch-on current Iₒₙ₂ lead to overcharging and undercharging of the liquid crystal capacitor and the storage capacitor 104, respectively. The higher switch-off currents I_{off1} and I_{off2} lead to leakage currents in the TFT 101. The overcharging, undercharging, and leakage currents cause abnormal charging or discharging of the liquid crystal capacitor and the storage capacitor 104. This is liable to degrade the display quality of the LCD device 10.

Accordingly, what is needed is an LCD device and a method for driving the LCD device which can overcome the above-described deficiencies.

### SUMMARY

In a first aspect, a liquid crystal display device includes a scanning voltage adjusting circuit, a scaler, and a liquid crystal display panel. The scanning voltage adjusting circuit is configured for detecting an environment temperature and generating a scanning voltage adjusting signal corresponding to the environment temperature. The scaler is capable of receiving the scanning voltage adjusting signal and generating a scanning voltage according to the scanning voltage adjusting signal. The liquid crystal display (LCD) panel is configured to be driven by the scanning voltage and thereby display images.

In a second aspect, a method for driving a liquid crystal display device is provided. The liquid crystal display device includes a scanning voltage adjusting circuit, a scaler, and a liquid crystal display panel. The method includes the following steps. The scanning voltage adjusting circuit detects an environment temperature and generates a scanning voltage adjusting signal corresponding to the environment temperature. The scaler receives the scanning voltage adjusting signal and generates a scanning voltage according to the scanning voltage adjusting signal to drive the liquid crystal display panel to display an image.

In a third aspect, a method for driving a liquid crystal display device is provided. The method includes the following steps: providing a liquid crystal display device comprising a scanning voltage adjusting circuit, a scaler, and a liquid crystal display panel; detecting an environment temperature and generating a scanning voltage adjusting signal corresponding to the environment temperature by the scanning voltage adjusting circuit; receiving the scanning voltage adjusting signal, and generating a scanning voltage according to the scanning voltage adjusting signal by the scaler; and driving the liquid crystal display panel with the scanning voltage to display an image.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is essentially an abbreviated circuit diagram of an LCD device according to a preferred embodiment of the present invention.

FIG. 2 is a flowchart summarizing an exemplary method for driving the LCD device of FIG. 1.

FIG. 3 is essentially an abbreviated circuit diagram of a conventional LCD device.

FIG. 4 shows current density-voltage curves of a sample TFT of the LCD device of FIG. 3 at different temperatures.

### DETAILED DESCRIPTION OF PREFERRED EMBODIMENTS

Reference will now be made to the drawings to describe various embodiments of the present invention in detail.

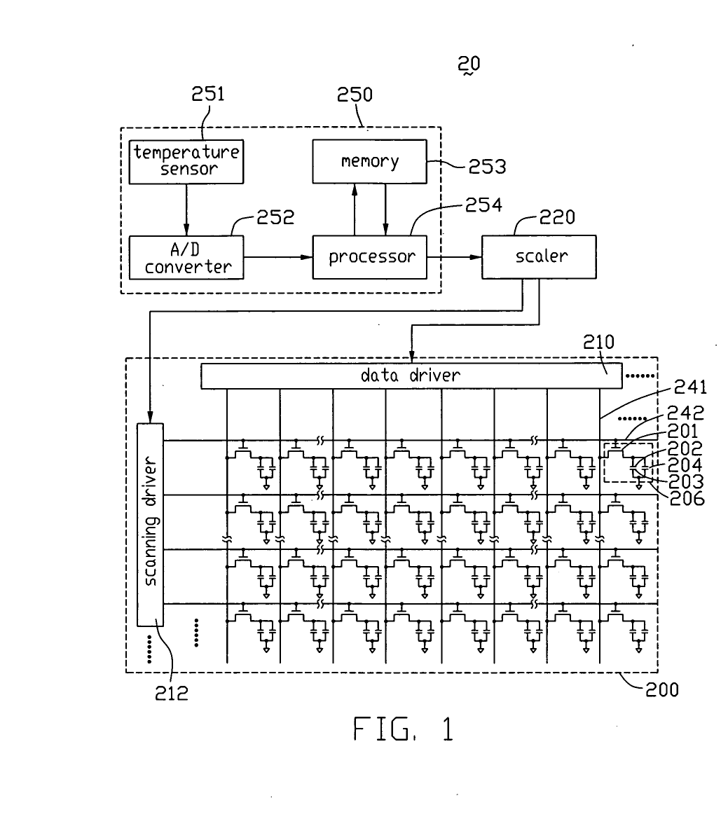

FIG. 1 is an abbreviated circuit diagram of an LCD device according to a preferred embodiment of the present invention. The LCD device 20 includes a scanning voltage adjusting circuit 250, a scaler 220, and an LCD panel 200.

The scanning voltage adjusting circuit 250 includes a temperature sensor 251, an analog-to-digital (A/D) converter 252, a memory 253, and a processor 254. The temperature sensor 251 can for example be a thermal resistor or a thermocouple, and is arranged at an outside of the LCD panel 200 for detecting an ambient temperature of the LCD panel 200. The temperature sensor 251 is connected to the A/D converter 252, and outputs analog temperature signals to the A/D converter 252. The A/D converter 252 receives the analog temperature signals, and sends digital temperature signals to the processor 254. The memory 253 is connected to the processor 254. The memory 253 is typically a non-volatile random access memory (NVRAM), which can for example be an electrically erasable programmable read-only memory (EEPROM). The processor 254 receives digital temperature signals from the A/D converter 252 and the memory 253, and then outputs scanning voltage adjusting signals to the scaler 220.

The scaler 220 receives the scanning voltage adjusting signals from the processor 254, and outputs scanning voltages and data voltages to the LCD panel 200.

The LCD panel 200 includes a data driver 210 receiving data signals from the scaler 220, a scanning driver 212 receiving scanning voltages from the scaler 220, a multiplicity of data lines 241 connected to the data driver 210, and a multiplicity of scanning lines 242 connected to the scanning driver 212. The data lines 241 are arranged parallel to each other, and each data line 241 extends parallel to a first direction. The scanning lines 242 are arranged parallel to each other, and each scanning line 242 extends parallel to a second direction that is perpendicular to the first direction. Thereby, the crossing data lines 241 and scanning lines 242 cooperatively define a multiplicity of pixel regions 206.

Each pixel region 206 has a thin film transistor (TFT) 201, a pixel electrode 202, a common electrode 203 generally opposite to the pixel electrode 202, a liquid crystal layer (not shown) sandwiched between the pixel electrode 202 and the common electrode 203, and a storage capacitor 104. The pixel electrode 202, the common electrode 203, and the liquid crystal layer sandwiched therebetween cooperatively define a liquid crystal capacitor (not labeled). The storage capacitor 204 is connected with the liquid crystal capacitor in parallel.

The TFT 201 includes a gate electrode (not labeled), a source electrode (not labeled), and a drain electrode (not labeled). The gate electrode is connected to the corresponding scanning line 142 for receiving scanning signals therefrom. The source electrode (not labeled) is connected to the corresponding data line 142 for receiving data signals therefrom. The drain electrode (not labeled) is connected to the pixel electrode 103 and the storage capacitor 104 for providing display signals thereto.

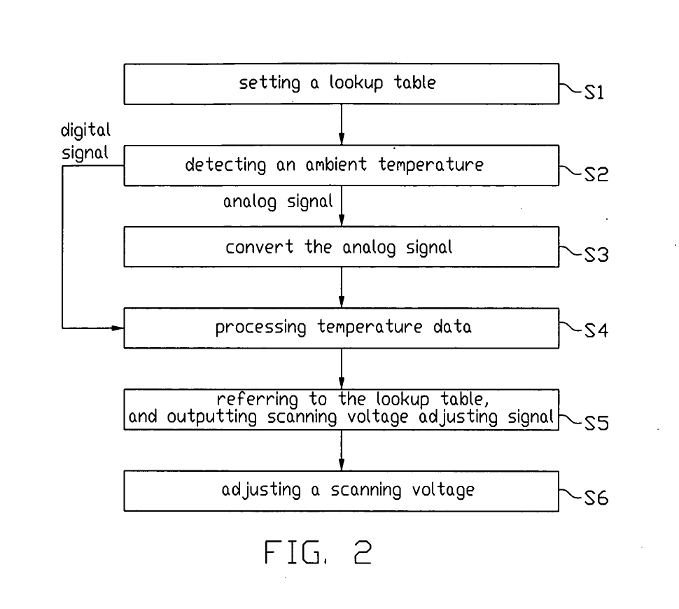

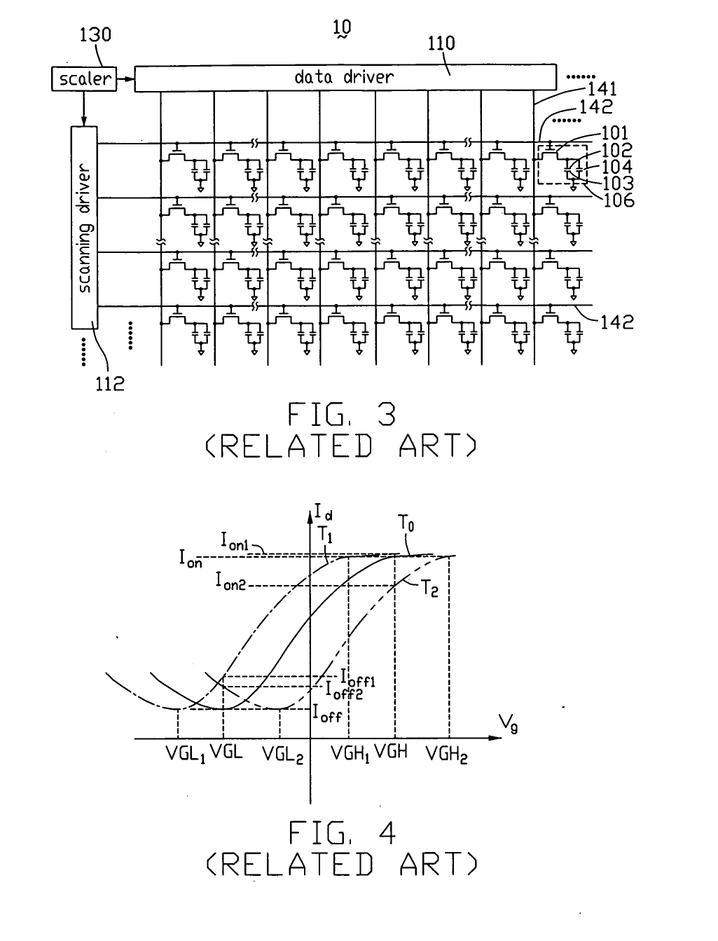

FIG. 2 is a flowchart summarizing an exemplary method for driving the LCD device 20. The method includes: step S1, setting a lookup table; step S2, detecting an ambient temperature; step S3, converting a temperature signal from an analog signal to a digital signal if the temperature signal is an analog signal; step S4, processing temperature data; step S5, referring to the lookup table, and outputting a scanning voltage adjusting signal; and step S6, adjusting a scanning voltage.

Regarding step S1, due to the complexity of LCD fabrication technology, the switch-on voltages VGH and switch-off voltages VGL of the TFTs 201 are usually different at different temperatures. Accordingly, the precise switch-on voltages VGH and switch-off voltages VGL corresponding to different temperatures T are obtained through experiments. Information on relationships of the switch-on voltage VGH versus the temperature T, and the switch-off voltage VGL versus the temperature T, are stored in the memory 253 in the form of a lookup table. In the lookup table, the information can for example be recorded in the form of eight-digit binary numbers, which range from 00,000,000 to 11,111,111. Thus, 256 steps (or levels) for the scanning voltage can be preset in the memory 253.

In step S2, the temperature sensor 251 detects an ambient temperature of the LCD panel 200, and outputs a corresponding temperature signal. The temperature sensor 251 can be a digital sensor that outputs digital temperature signals, or an analog sensor that outputs analog temperature signals.

In step S3, on a condition that the temperature sensor 251 outputs analog temperature signals, the A/D converter 252 converts the analog temperature signal into a digital temperature signal. The digital temperature signal is then transmitted to the processor 254. In this embodiment, the digital temperature signal is transmitted in the form of an eight-digit binary number in accordance with the temperature information stored in the memory 253. Alternatively, on a condition that the temperature sensor 252 outputs a digital temperature signal, then step S3 is omitted. The digital temperature information is transmitted to the processor 254 via the AID converter 252 unchanged.

In step S4, the processor 254 processes the digital temperature signal in order to confirm the ambient temperature conditions. The processing can for example include ignoring invalid data, calculating average temperature values, weighting average temperature values, and variance analysis of the temperature data. Accordingly, the ambient temperature conditions can be confirmed.

In step S5, when the ambient temperature conditions are confirmed, the processor 254 refers to the lookup table of the memory 253 to find the listed temperature Tₓ that is the nearest one to the confirmed ambient temperature. Then the switch-on voltage VGHₓ and the switch-off voltage VGLₓ corresponding to the temperature Tₓ are set to be the scanning voltages of the TFT 201 of the LCD panel 200. In order to set up the scanning voltages of the TFT 201, the processor 254 outputs a scanning voltage adjusting signal to the scaler 220.

In step S6, the scaler 220 outputs the switch-on voltage VGHₓ and switch-off voltage VGLₓ to the scanning driver 212 according to the voltage adjusting signal. Then the scanning driver 212 outputs the switch-on voltage VGHₓ and the switch-off voltage VGLₓ to switch the TFTs 201 of the LCD panel 200 for displaying of images.

In the above-described LCD device 200, the temperature sensor 251 of the scanning voltage adjusting circuit 250 is used to detect the ambient temperature. The processor 254 finds an appropriate switch-on voltage VGH and an appropriate switch-off voltage VGL of the TFTs 201 according to the lookup table stored in the memory 253, and sends a scanning voltage adjusting signal to the scaler 220 to adjust the scanning voltages output therefrom. Therefore TFTs 201 in the LCD panel 200 are switched on with a higher and stable current flowing therethrough, and are switched off with a lowest current flowing therethrough in accordance with the ambient environment. Accordingly, undercharging, overcharging, and leakage current phenomena are reduced or even eliminated, and the display quality of the LCD device 20 can be significantly improved.

In an alternative embodiment, the temperature sensor 251 can instead be arranged at a non-display area of the LCD panel 220. Thus the temperature sensor 251 can detect a precise working temperature of the TFTs 201, thereby enabling precise adjusting of the scanning voltage. In addition, more than one temperature sensor 251 can be arranged at different positions on or in the LCD panel 220. Thus the temperature sensors 251 may detect an overall temperature condition of the LCD panel 220. Furthermore, the scanning voltage adjusting circuit 250 can be formed on a glass substrate used in the LCD panel 200 through system on glass (SOG) technology or chip on glass (COG) technology. This not only increases production efficiency, but also lowers a cost of the LCD device 200.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a scanning voltage adjusting circuit configured for detecting an environment temperature and generating a scanning voltage adjusting signal corresponding to the environment temperature;
a scaler capable of receiving the scanning voltage adjusting signal and generating a scanning voltage according to the scanning voltage adjusting signal; and
a liquid crystal display (LCD) panel configured to be driven by the scanning voltage and thereby display images.

2. The liquid crystal display device of claim 1, wherein the scanning voltage adjusting circuit comprises a memory, at least one temperature sensor, and a processor, information on relationships of scanning voltage versus temperature are stored in the memory, the at least one temperature sensor is configured to detect the environment temperature and send at least one corresponding environment temperature signal to the processor, and the processor is configured to process the at least one environment temperature signal and output a scanning voltage adjusting signal to the scaler according to the information on relationships of scanning voltage versus temperature.

3. The liquid crystal display device of claim 2, wherein the memory is a non-volatile random access memory.

4. The liquid crystal display device of claim 2, wherein the at least one temperature sensor is a digital type temperature sensor.

5. The liquid crystal display device of claim 2, wherein the scanning voltage adjusting circuit further comprises an analog-to-digital converter, the at least one temperature sensor comprises at least one analog type temperature sensor, and the temperature signal detected by the at least one analog type temperature sensor is converted to a digital temperature signal by the analog-to-digital converter and is then sent to the processor.

6. The liquid crystal display device of claim 2, wherein at least one of the at least one temperature sensor is provided at a non-display area of the LCD panel.

7. The liquid crystal display device of claim 2, wherein the at least one temperature sensor is one of a thermal resistor and a thermoelectric couple.

8. The liquid crystal display device of claim 2, wherein the LCD panel comprises a scanning driver connected to the scaler, a data driver connected to the scaler, a plurality of scanning lines connected to the scanning driver, a plurality of data lines connected to the data driver, a plurality of thin film transistors, and a plurality of pixel electrodes, each of the thin film transistors has a gate electrode connected to a corresponding scanning line, a source electrode connected to a corresponding data line, and a drain electrode connected to a corresponding pixel electrode.

9. The liquid crystal display device of claim 1, wherein the scanning voltage adjusting circuit is formed on the LCD panel through system on glass technology or chip on glass technology.

10. A method for driving a liquid crystal display device, the liquid crystal display device comprising a scanning voltage adjusting circuit, a scaler, and a liquid crystal display panel, the method comprising:
the scanning voltage adjusting circuit detecting an environment temperature and generating a scanning voltage adjusting signal corresponding to the environment temperature; and
the scaler receiving the scanning voltage adjusting signal, and generating a scanning voltage according to the scanning voltage adjusting signal to drive the liquid crystal display panel to display an image.

11. The method of claim 10, wherein the scanning voltage adjusting circuit comprises a memory, a temperature sensor, and a processor, information on relationships of scanning voltage versus temperature are stored in the memory, and the method further comprises: the temperature sensor detecting the environment temperature, and sending a corresponding environment temperature signal to the processor; and the processor comparing the environment temperature signal with the information stored in the memory to confirm one or more scanning voltages corresponding to the environment temperature, and sending a scanning voltage adjusting signal according to the one or more scanning voltages.

12. The method of claim 11, wherein the information on relationships of scanning voltage versus temperature comprises relationships of switch-on voltage versus temperature.

13. The method of claim 11, wherein the information on relationships of scanning voltage versus temperature comprises relationships of switch-off voltage versus temperature.

14. The method of claim 11, wherein the memory is a non-volatile random access memory.

15. The method of claim 11, wherein the temperature sensor is one of a thermal resistor and a thermoelectric couple.

16. The method of claim 11, wherein the temperature sensor is provided at a non-display area of the LCD panel.

17. The method of claim 11, wherein the scanning voltage adjusting circuit further comprises an analog-to-digital converter, and the temperature sensor is an analog type temperature sensor, and the method further comprises: the analog-to-digital converter converting the temperature signal detected by the temperature sensor to a digital temperature signal, and sending the digital temperature signal to the processor.

18. A method for driving a liquid crystal display device, comprising:
providing a liquid crystal display device comprising a scanning voltage adjusting circuit, a scaler, and a liquid crystal display panel;
detecting an environment temperature and generating a scanning voltage adjusting signal corresponding to the environment temperature by the scanning voltage adjusting circuit;
receiving the scanning voltage adjusting signal, and generating a scanning voltage according to the scanning voltage adjusting signal by the scaler; and
driving the liquid crystal display panel with the scanning voltage to display an image.

19. The method of claim 18, wherein the scanning voltage adjusting circuit comprises a memory, a temperature sensor, and a processor, information on relationships of scanning voltage versus temperature are stored in the memory, and the method further comprises: the temperature sensor detecting the environment temperature, and sending a corresponding environment temperature signal to the processor; and the processor comparing the environment temperature signal with the information stored in the memory to confirm one or more scanning voltages corresponding to the environment temperature, and sending a scanning voltage adjusting signal according to the one or more scanning voltages.

20. The method of claim 19, wherein the information on relationships of scanning voltage versus temperature comprises relationships of switch-on voltage versus temperature and relationships of switch-off voltage versus temperature.
